(19) United States
(12) Patent Application Publication
(10) Pub. No.: US 2010/0329211 A1
(43) Pub. Date: Dec. 30, 2010

(54) Method and Apparatus for Handling Inter-RAT Handover

(76) Inventor: Meng-Hui Ou, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/825,367

(22) Filed: Jun. 29, 2010

Related U.S. Application Data
(60) Provisional application No. 61/221,093, filed on Jun. 29, 2009.

(51) Int. Cl. H04W 36/00

(52) U.S. Cl. 370/331

(57) ABSTRACT

A method for handling inter-RAT handover in a user equipment (UE) of a wireless communication system is disclosed. The method includes steps of performing a handover procedure to handover the UE from other communication system to the wireless communication system; receiving an RRC Connection Reconfiguration message, and configuring radio link failure timers and constants of the UE according to whether the RRC Connection Reconfiguration message includes an UE specific configuration parameter for the radio link failure timers and constants.

### CROSS REFERENCE TO RELATED APPLICATIONS

This application claims the benefit of U.S. Provisional Application No. 61/221,093, filed on Jun. 29, 2009 and entitled “ Method and apparatus for reusing unused MBSFN subframes in a wireless communication system”, the contents of which are incorporated herein by reference.

### BACKGROUND OF THE INVENTION

1. Field of the Invention

The present invention relates to a method and apparatus for handling inter-RAT (Radio Access Technology) handover, and more particularly, to a method and apparatus for handling inter-RAT handover in an user equipment of a wireless communication system, so as to effectively configure radio link failure timers and constants.

2. Description of the Prior Art

Long Term Evolution (LTE) wireless communication system, an advanced high-speed wireless communication system established upon the 3G mobile telecommunication system, supports only packet-switched transmission, and tends to implement both Medium Access Control (MAC) layer and Radio Link Control (RLC) layer in one single communication site, such as in base stations (Node Bs) alone rather than in Node Bs and RNC (Radio Network Controller) respectively, so that the system structure becomes simple.

In LTE system, to keep an effective connection between a user equipment (UE) and a Node B after the connection is established, the UE starts a timer T310 if the UE detects a radio link problem, e.g. the UE detects consecutive “out-of-sync” indications from a physical layer. The number of consecutive “out-of-sync” indications is defined by a configurable constant N310. If the radio link problem is not recovered before the timer T310 expires, the UE determines a radio link failure (RLF) occurs, and triggers an RRC connection re-establishment procedure, to re-establish a normal connection.

Besides, when the timer T310 is running, the UE shall stop the timer T310 if the radio link problem is recovered, e.g. the UE receives consecutive “in-sync” indications from a physical layer. The number of consecutive “in-sync” indications is defined by a configurable constant N311.

When the RRC connection re-establishment procedure is initiated, the UE starts a timer T311 to control the duration of cell selection. If the UE cannot successfully complete a cell selection procedure before expiry of the timer T311, or the cell selected by the UE belongs to other radio access technology (RAT), then the connection is determined not able to be recovered, and the UE enters into an RRC idle mode. Detailed operations of the RLF timers and constants can be referred in related technical specifications, and is not given herein.

According to the current specifications (3GPP TS 36.331 v8.5.0, “E-UTRA RRC Protocol Specification (Release 8)”), configurations of the RLF related timers and constants are transmitted by the network via system information broadcast. That means, all UEs in a cell are configured with the same RLF timers and constants.

However, in the 3GPP meeting document R2-093802, it is considered that having a single setting for all RLF related timers and constants in a cell where wide range of services with different Quality of Service (QoS) classes and delay requirements may be deployed is seen as non-optimal. Thus, the 3GPP meeting document R2-093803 proposes to use a new RRC parameter, i.e. an information element (IE) rlf-TimersAndConstants, to configure the RLF timers and constants of each UE, respectively. The IE rlf-TimersAndConstants is included in an IE RadioResourceConfigDedicated, while the IE RadioResourceConfigDedicated is transmitted in an RRC Connection Reconfiguration message for carrying UE specific RRC configurations.

When the UE moves from another communication system such as an Universal Mobile Telecommunications System (UMTS), for example, to the LTE system, the UE performs an inter-RAT handover procedure, e.g. a handover to evolved universal terrestrial radio access (E-UTRA) procedure. The inter-RAT handover (e.g. handover to E-UTRA) procedure is performed by the network with other radio access technology sending the RRC Connection Reconfiguration message to the UE, for re-configuring the UE. However, if the text proposal in R2-093803 is adopted in the specifications, when the RRC Connection Reconfiguration message is received in the inter-RAT handover (e.g. handover to E-UTRA) procedure, the UE still uses the default values to configure the timers T310, T311 and the constants N310, N311.

In this case, even if the RRC Connection Reconfiguration message includes the IE rlf-TimersAndConstants, the UE specific configuration in the IE rlf-TimersAndConstants can never be applied to the RLF timers and constants of the UE, such that the system performance is affected. Thus, there is a need to solve this problem.

### SUMMARY OF THE INVENTION

It is therefore an objective of the present invention to provide a method and apparatus for handling inter-RAT handover in an UE of a wireless communication system.

According to the present invention, a method for handling inter-RAT handover in an UE of a wireless communication system is disclosed. The method includes steps of performing a handover procedure to handover the UE from another communication system to the wireless communication system; receiving an RRC Connection Reconfiguration message; and configuring radio link failure timers and constants of the UE according to whether the RRC Connection Reconfiguration message includes an UE specific configuration parameter for the radio link failure timers and constants.

According to the present invention, a communications device for handling inter-RAT handover in an UE of a wireless communication system is disclosed. The communications device includes a processor for executing a program, and a memory, coupled to the processor, for storing the program. The program includes steps of performing a handover procedure to handover the UE from another communication system to the wireless communication system; receiving an RRC Connection Reconfiguration message; and configuring radio link failure timers and constants of the UE according to whether the RRC Connection Reconfiguration message includes an UE specific configuration parameter for the radio link failure timers and constants.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a diagram of program code of FIG. 2.

FIG. 4 is a flowchart of a process according to an embodiment of the present invention.

### DETAILED DESCRIPTION

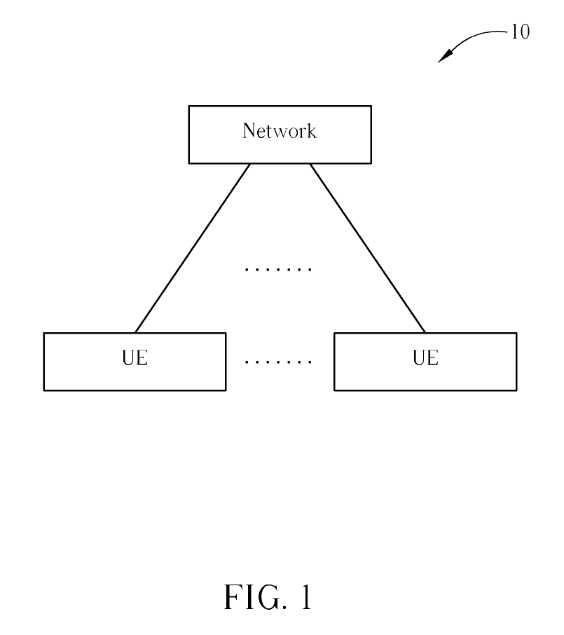

Please refer to FIG. 1, which illustrates a schematic diagram of a wireless communications system 10. The wireless communications system 10 is preferred to be a Long Term Evolution (LTE) wireless communication system, and is briefly composed of a network and a plurality of user equipments (UEs). In FIG. 1, the network and the UEs are simply utilized for illustrating the structure of the wireless communications system 10. Practically, the network may comprise a plurality of base stations (Node Bs), radio network controllers and so on according to actual demands, and the UEs can be devices such as mobile phones, computer systems, etc.

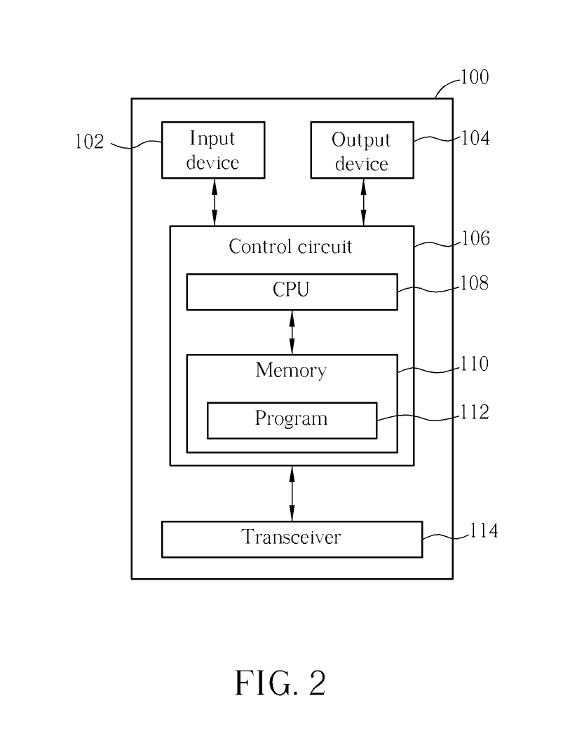

Please refer to FIG. 2, which is a functional block diagram of a communications device 100 in a wireless communications system. The communications device 100 can be utilized for realizing the UEs or the network in FIG. 1. For the sake of brevity, FIG. 2 only shows an input device 102, an output device 104, a control circuit 106, a central processing unit (CPU) 108, a memory 110, a program 112, and a transceiver unit 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver unit 114 is used to receive and transmit wireless signals, delivering received signals to the control circuit 106, and outputting signals generated by the control circuit 106 wirelessly. From a perspective of a communications protocol framework, the transceiver unit 114 can be seen as a portion of Layer 1, and the control circuit 106 can be utilized to realize functions of Layer 2 and Layer 3.

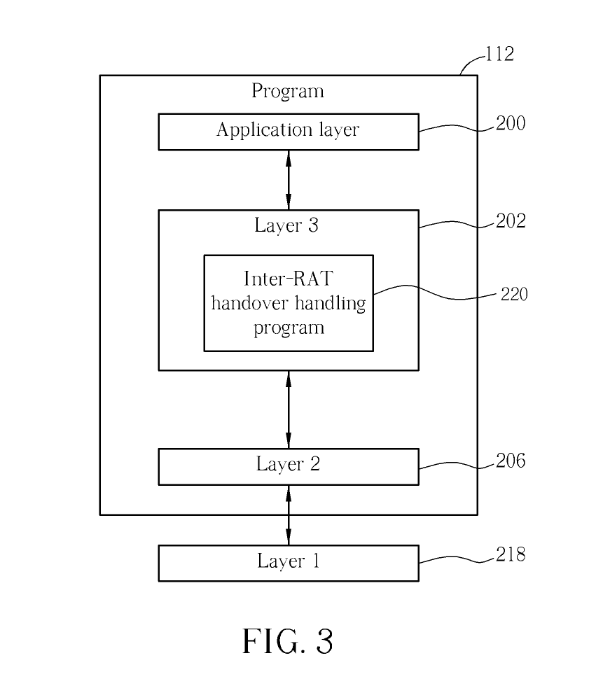

Please continue to refer to FIG. 3. FIG. 3 is a diagram of the program 112 shown in FIG. 2. The program 112 includes an application layer 200, a Layer 3 202, and a Layer 2 206, and is coupled to a Layer 1 218. The Layer 3 202 performs radio resource control. The Layer 2 206 comprises a Radio Link Control (RLC) layer and a Medium Access Control (MAC) layer, and performs link control. The Layer 1 218 performs physical connections.

In the LTE system, the Layer 3 202 is configured with radio link failure timers and constants, for controlling radio link failure related actions. Detailed operations can be referred to the prior art, and is not narrated again herein. Besides, the network sends an UE specific configuration parameter, i.e. an information element (IE) rlf-TimersAndConstants to the UE via an RRC Connection Reconfiguration message, to configure the RLF timers and constants of each UE, respectively. As a result, UEs in a cell can have different configurations of radio link failure timers and constants, to meet different QoS and delay requirements.

When the UE moves from another communication system such as an Universal Mobile Telecommunications System (UMTS), for example, to the LTE system, the UE performs an inter-RAT (Radio Access Technology) handover procedure, e.g. a handover to E-UTRA procedure. The inter-RAT handover (e.g. handover to E-UTRA) procedure is performed by the network with other radio access technology sending the RRC Connection Reconfiguration message to the UE, for re-configuring the UE. However, in the prior art, no matter whether the RRC Connection Reconfiguration message includes the IE rlf-TimersAndConstants, the UE always uses default values to configure the timers T310, T311 and the constants N310, N311, resulting in that the UE specific configuration cannot be applied in the inter-RAT handover (e.g. handover to E-UTRA) procedure.

In such a situation, the embodiment of the present invention provides an inter-RAT handover handling program 220 in the program 112, for effectively performing the inter-RAT handover procedure to solve the problem that the UE specific configuration of the RLF timers and constants cannot be applied, so as to enhance the system performance.

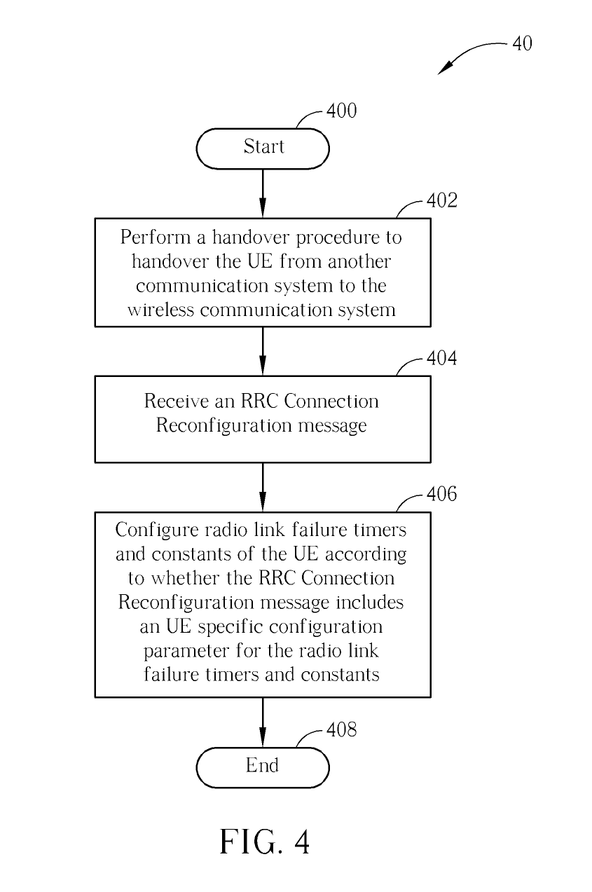

Please refer to FIG. 4, which illustrates a schematic diagram of a process 40. The process 40 is utilized for performing inter-RAT handover in an UE of the wireless communications system 10, and can be compiled into the inter-RAT handover handling program 220. The process 40 includes the following steps:

Step 400: Start.

Step 402: Perform a handover procedure to handover the UE from another communication system to the wireless communication system.

Step 404: Receive an RRC Connection Reconfiguration message.

Step 406: Configure radio link failure timers and constants of the UE according to whether the RRC Connection Reconfiguration message includes an UE specific configuration parameter for the radio link failure timers and constants.

Step 408: End.

According to the process 40, the UE performs the inter-RAT handover procedure to handover the UE from another communication system to the wireless communication system. In the inter-RAT handover procedure, when the RRC Connection Reconfiguration message is received, the UE configures the radio link failure timers and constants according to whether the RRC Connection Reconfiguration message includes the UE specific configuration parameter for the radio link failure timers and constants.

In the embodiment of the present invention, the UE specific configuration parameter is the IE rlf-TimersAndConstants. Besides, the radio link failure timers and constants can be a timer T310, a timer T311, a constant N310 or a constant N311, but are not limited to these.

Therefore, when the RRC Connection Reconfiguration message is received in the inter-RAT handover (e.g. handover to E-UTRA) procedure, the UE shall first determine whether the RRC Connection Reconfiguration message includes the IE rlf-TimersAndConstants.

When the RRC Connection Reconfiguration message includes the IE rlf-TimersAndConstants, the UE uses the values in the IE. rlf-TimersAndConstants to configure the radio link failure timers and constants. Conversely, when the RRC Connection Reconfiguration message does not include the IE rlf-TimersAndConstants, the UE then uses default values to configure the radio link failure timers and constants.

Consequently, the UE can apply the UE specific configuration for the radio link failure timers and constants in the inter-RAT handover (e.g. handover to E-UTRA) procedure immediately. Such that no additional RRC Connection Reconfiguration message is required to send the UE specific configuration after the inter-RAT handover (e.g. handover to E-UTRA) procedure is complete.

In summary, when the UE receives the RRC Connection Reconfiguration message due to handover to the LTE system, the UE determines to apply the UE specific configuration for the radio link failure timers and constants when the RRC Connection Reconfiguration message includes the IE rlf-TimersAndConstants. As a result, in the embodiment of the present invention, the radio link failure timers and constants can be configured effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling inter-RAT (Radio Access Technology) handover in an user equipment (UE) of a wireless communication system, the method comprising:
performing a handover procedure to handover the UE from another communication system to the wireless communication system;
receiving an RRC Connection Reconfiguration message; and
configuring radio link failure timers and constants of the UE according to whether the RRC Connection Reconfiguration message includes an UE specific configuration parameter for the radio link failure timers and constants.

2. The method of claim 1, wherein the UE specific configuration parameter is an Information Element (IE) rlf-TimersAndConstants.

3. The method of claim 1, wherein configuring the radio link failure timers and constants of the UE according to whether the RRC Connection Reconfiguration message includes the UE specific configuration parameter comprises:
using the UE specific configuration parameter to configure the radio link failure timers and constants of the UE when the RRC Connection Reconfiguration message includes the UE specific configuration parameter.

4. The method of claim 1, wherein configuring the radio link failure timers and constants of the UE according to whether the RRC Connection Reconfiguration message includes the UE specific configuration parameter comprises:
using a default configuration to configure the radio link failure timers and constants of the UE when the RRC Connection Reconfiguration message does not include the UE specific configuration parameter.

5. The method of claim 1, wherein the radio link failure timers and constants comprises a timer T310, a timers T311, a constant N310 and/or a constant N311.

6. The method of claim 1, wherein the wireless communication system is a Long Term Evolution (LTE) wireless communication system.

7. The method of claim 1, wherein the handover procedure is a handover to E-UTRA procedure.

8. A communication device for handling inter-RAT (Radio Access Technology) handover in a user equipment (UE) of a wireless communication system, the communication device comprising:
a processor for executing a program; and
a memory coupled to the processor for storing the program; wherein the program comprises:
performing a handover procedure to handover the UE from another communication system to the wireless communication system;
receiving an RRC Connection Reconfiguration message; and
configuring radio link failure timers and constants of the UE according to whether the RRC Connection Reconfiguration message includes an UE specific configuration parameter for the radio link failure timers and constants.

9. The communication device of claim 8, wherein the UE specific configuration parameter is an Information Element (IE) rlf-TimersAndConstants.

10. The communication device of claim 8, wherein configuring the radio link failure timers and constants of the UE according to whether the RRC Connection Reconfiguration message includes the UE specific configuration parameter comprises:
using the UE specific configuration parameter to configure the radio link failure timers and constants of the UE when the RRC Connection Reconfiguration message includes the UE specific configuration parameter.

11. The communication device of claim 8, wherein configuring the radio link failure timers and constants of the UE according to whether the RRC Connection Reconfiguration message includes the UE specific configuration parameter comprises:
using a default configuration to configure the radio link failure timers and constants of the UE when the RRC Connection Reconfiguration message does not include the UE specific configuration parameter.

12. The communication device of claim 8, wherein the radio link failure timers and constants comprises a timer T310, a timer T311, a constant N310 and/or a constant N311.

13. The communication device of claim 8, wherein the wireless communication system is a Long Term Evolution (LTE) wireless communication system.

14. The communication device of claim 8, wherein the handover procedure is a handover to E-UTRA procedure.
